(19) United States
(12) Patent Application Publication
(10) Pub. No.: US 2009/0027303 A1
(43) Pub. Date: Jan. 29, 2009

(54) DISPLAY APPARATUS WITH RESISTOR MULTIPLEXER

(76) Inventors: Alan R. Arthur, Salem, OR (US); Peter J. Fricke, Corvallis, OR (US); Ronald A. Hellekson, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/782,755

(22) Filed: Jul. 25, 2007

(51) Int. Cl. G09G 3/36; G09G 3/00

(52) U.S. Cl. 345/1.3

(57) ABSTRACT

Embodiments 1of an apparatus with first and second display panels and a resistor multiplexer are disclosed.

### BACKGROUND

Electronic display devices, such as electronic readers (e-readers), provide textual and other visual information to a user. E-readers typically include a single display page that is periodically updated to provide the information to the user. While information is being updated, a user generally waits for the information to be displayed. The amount of time it takes for information to be updated on an e-reader is referred to the refresh rate, and it is generally desirable to minimize the refresh rate of an e-reader. Minimizing the refresh time of an e-reader, however, may result in additional costs or a limit on the display size of an e-reader.

### BRIEF DESCRIPTION OF THE DRAWINGS

FIGS. 1A-1C are block diagrams illustrating embodiments of an electronic reader (e-reader).

FIG. 2 is a block diagram illustrating an embodiment of display panels connected to a resistor multiplexer.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

According to one embodiment, a multi-page electronic reader (e-reader) with a resistor multiplexer is provided. The e-reader is configured to display multiple pages of textual or other visual information simultaneously to allow one page of information to be updated while another is being viewed by a user. The e-reader includes a resistor multiplexer to allow portions of the electronic circuitry for driving the pages of the display to be shared.

By displaying multiple pages simultaneously, the embodiments of the e-reader described herein may more closely emulate the experience of reading a book for user as opposed to reading a single page display. In addition, the e-reader may be constructed with fewer and/or lower cost components that have a slower refresh rate than other embodiments of with addition or higher cost components. With fewer components, the size, weight, cost, and complexity of the e-reader may be reduced.

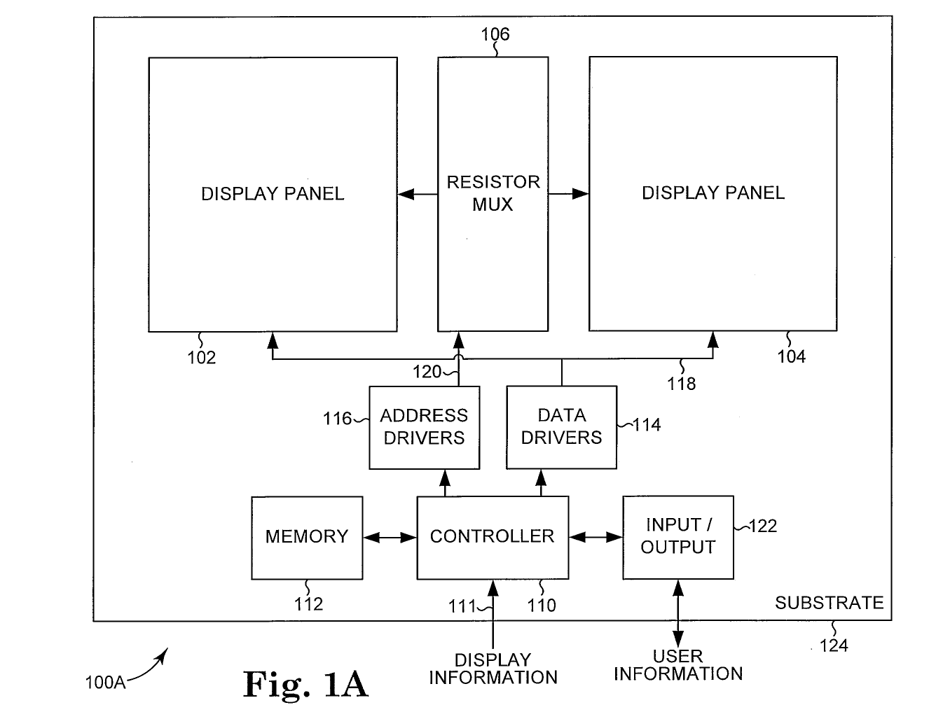

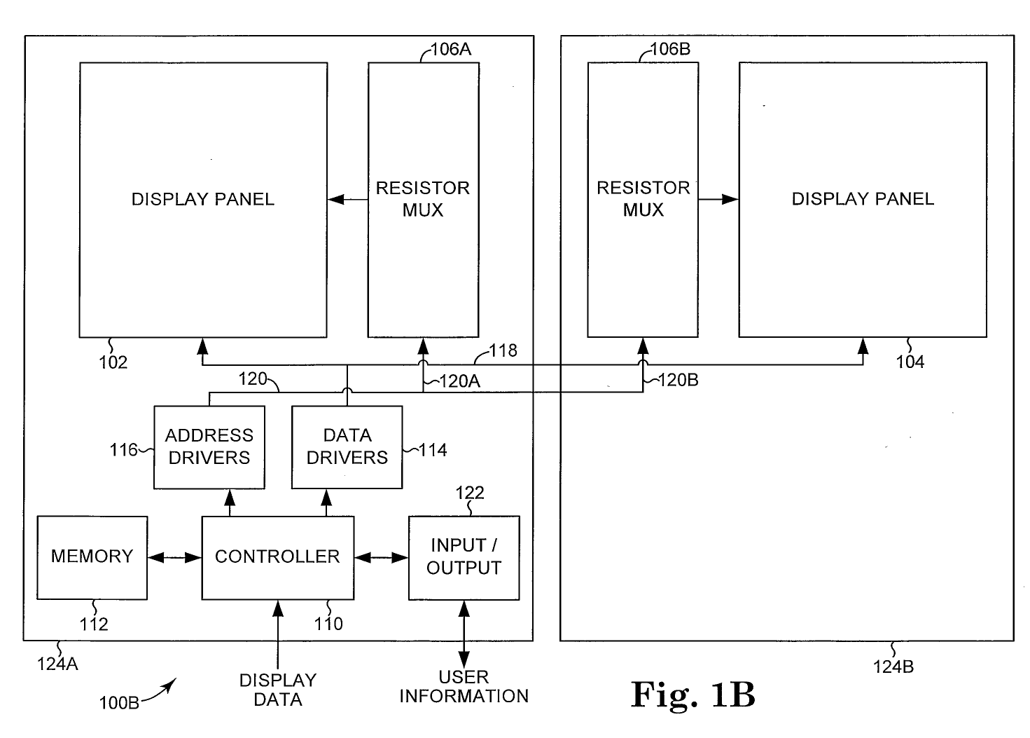

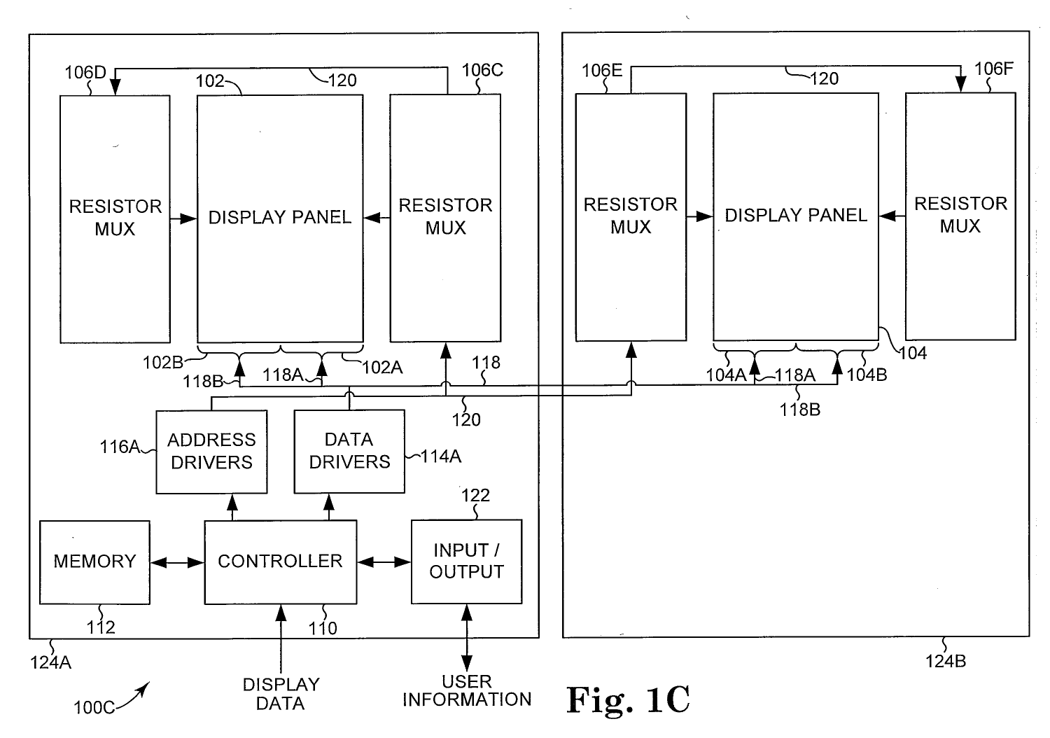

Embodiments of a multi-page e-reader will now be described with reference to FIGS. 1A-1C.

In FIG. 1A, an embodiment of a multi-page e-reader 100A includes display panels 102 and 104, a resistor multiplexer (mux) 106, a controller 110, a memory 112, data drivers 114, address drivers 116, and an input/output unit 122.

E-reader 100A receives display information from any suitable image data source (not shown) such as a computer system, a mobile device, a storage system, or a storage media. E-reader 100A connects to the display information source by any suitable connection 111 that allows display information to be received by e-reader 100A such as a wired or wireless point-to-point connection or a wired or wireless network connection. The network connection may connect to a local area network (LAN), a wide area network (WAN), or a global communications network such as the Internet.

A controller 110 receives the display information and stores the display information in memory 111. Controller 110 performs any suitable processing on the display information and causes the display information to be displayed to a user on display panels 102 and 104 by providing the display information and control signals to data drivers 114 and address drivers 116. Controller 110 may be configured to execute instructions stored in memory 112 to operate e-reader 100A.

Memory 112 is any suitable storage medium that is accessible to controller 110 to allow controller 110 to access and store instructions and/or display information. Memory 112 may include any suitable type and/or combination of volatile and non-volatile memory devices in any suitable configuration.

Display panels 102 and 104 are each any suitable display unit, such as an electrophoretic display panel or a liquid crystal display (LCD) display panel, configured to display textual or other visual information to a user. Each display panel 102 and 104 includes a pixel array of individual pixels in any suitable arrangement such as rows and columns, and each display panel 102 and 104 may flexible or rigid. In one embodiment, each display panel 102 and 104 includes a pixel array of 1650 rows by 1275 columns. In other embodiments, each display panel 102 and 104 may include other sizes of pixel arrays.

Data drivers 114 generate and provide driving signals to columns of pixels of display panels 102 and 104 in response to display information and control signals from controller 110. Data drivers 114 form the driving signals by providing two or more different voltage levels on driver lines 118 at different times. In one embodiment, data drivers 114 include a series of 1275 drivers that generate and provide driving signals to 1275 columns of pixels in each of display panels 102 and 104. In other embodiments, data drivers 114 include other numbers of drivers that provide driving signals to other numbers of columns of pixels in each of display panels 102 and 104.

Address drivers 116 generate and provide driving signals to rows of pixels of display panels 102 and 104 in response to display information and control signals from controller 110. Address drivers 116 form the driving signals by providing two or more different voltage levels on driver lines 120 at different times. In one embodiment, address drivers 116 include a series of 600 drivers that generate and provide driving signals to resistor multiplexer 106. In other embodiments, address drivers 116 include other numbers of drivers that provide driving signals to resistor multiplexer 106.

Resistor multiplexer 106 receives the driving signals from address drivers 116 on driver lines 120 and provides the driving signals to display panels 102 and 104. Display panels 102 and 104 display information in response to the driving signals from resistor multiplexer 106 and the driving signals from data drivers 114.

Input/output unit 122 receives user information from and provides user information to a user. Input/output unit 122 includes any number and types of input and/or output devices to allow a user provide user information to and receive user information from e-reader 100A. Examples of input and output devices include a touch screen mechanism, a keypad, buttons, and a pointing or selecting device. In one embodiment, input/output unit 122 receives user information from a user that indicates when display panel 102 and display panel 104 are to be updated with new display information. For example, a user may provide an indication that causes a next page in a series of pages of display information to be displayed by display panel 102 or display panel 104.

Display panels 102 and 104, resistor multiplexer 106, controller 110, memory 112, data drivers 114, address drivers 116, and input/output unit 122 are mounted on, attached to, integrally formed with, or otherwise affixed to a substrate 124. Substrate 124 may made of a rigid or flexible material or combination of materials. Display panels 102 and 104 may be oriented in any suitable arrangement on substrate 124. For example, display panels 102 and 104 may be positioned adjacent to one another or on opposite sides of substrate 124. Display panels 102 and 104 may also be positioned such that they come together when substrate 124 is folded along an axis between display panels 102 and 104 and separate when substrate 124 is unfolded along the axis.

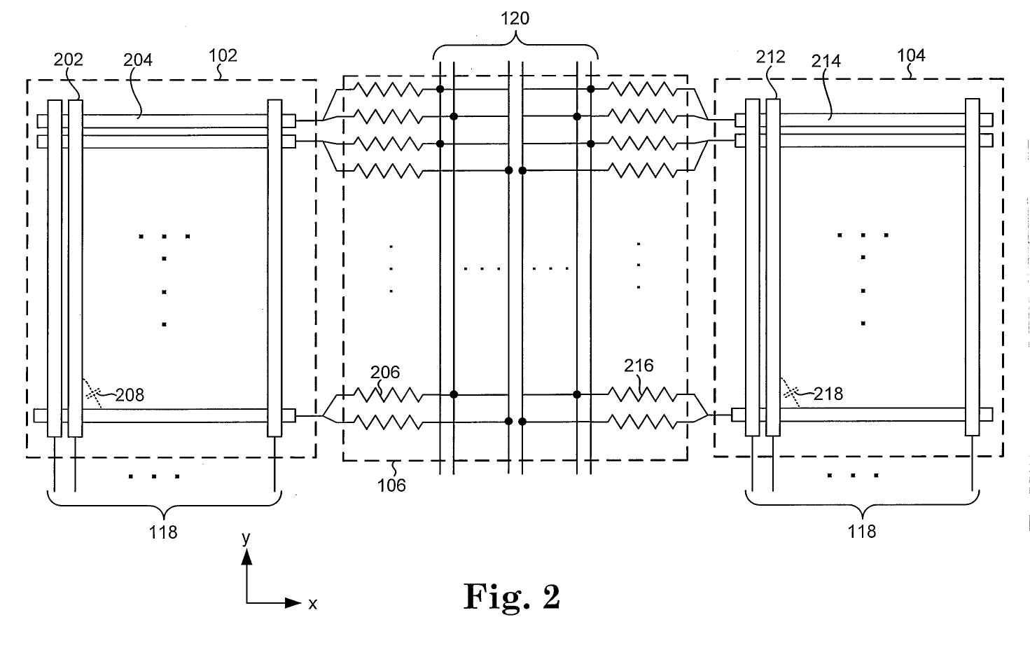

Additional details of resistor multiplexer 106 and display panels 102 and 104 are shown in FIG. 2. As shown in FIG. 2, driver lines 118 connect to respective column electrodes 202 in display panel 102 and to respective column electrodes 212 in display panel 104. Accordingly, in one embodiment, the number of driver lines 118 is equal to the number of column electrodes 202 in display panel 102, and the number of driver lines 118 is equal to the number of column electrodes 212 in display panel 104.

The series of electrodes 202 extend generally in parallel along the y-direction across the pixel array of display panel 102 in a plane on one side of the pixel array (not shown), and the series of electrodes 212 extend generally in parallel along the y-direction across the pixel array of display panel 104 in a plane on one side of the pixel array (not shown). Data drivers 114 directly drive the series of electrodes 202 and the series of electrodes 212 by providing driving signals on driver lines 118.

Driver lines 120 each connect, via a resistor 206, to one or more row electrodes 204 in display panel 102 and one or more row electrodes 214 in display panel 104. Each electrode 204 and each electrode 214 connects via a resistor 206 to two or more driver lines 120. Accordingly, each of the series of electrodes 204 and the series of electrodes 214 is connected to a respective plurality of the series of driver lines 120 via a respective impedance formed by a resistor 206 and the driving signals contained by each of the plurality of the driver lines 120 are independent of each other. The pluralities of driver lines 120 include one set of the pluralities of driver lines 120 that connects to the series of electrodes 204 and another set of the pluralities of driver lines 120 that connects to the series of electrodes 214 where these sets of pluralities are mutually exclusive.

The series of electrodes 204 extend generally in parallel along the x-direction across the pixel array of display panel 102 in a plane on the opposite side of the pixel array (not shown) from the series of electrodes 202, and the series of electrodes 214 extend generally in parallel along the x-direction across the pixel array of display panel 104 in a plane on the opposite side of the pixel array (not shown) from the series of electrodes 214. Electrodes 204 are generally perpendicular to electrodes 202 with reference to a plane that includes the pixel array of display panel 102, and electrodes 214 are generally perpendicular to electrodes 212 with reference to a plane that includes the pixel array of display panel 104.

The number of driver lines 120 is less than the number of electrodes 204 in display panel 102, and the number of driver lines 120 is less than the number of electrodes 214. The series of electrodes 204 may connect to a set of driver lines 120 that overlaps with or is mutually exclusive from the set of driver lines 120 that connect to the series of electrodes 214.

Address drivers 116 drive the series of electrodes 204 and the series of electrodes 214 by providing driving signals on the two or more driver lines 120 for each of electrodes 204 and 214. The combination of driving signals on the two or more driver lines 120 may be referred to as a codeword for each of electrodes 204 and 214. Because the driving signals contained by each combination of two or more driver lines 120 are independent of each other, address drivers 116 provide a different codeword on driver lines 120 for each electrode 204 and for each electrode 214. Each electrode 204 and 214 corresponds to a different codeword or combination of driving signals on driver lines 120.

The subsets of codewords used to drive electrodes 204 and 214, respectively, are mutually exclusive. Accordingly, address drivers 116 provide one subset of codewords to drive electrodes 204 and another subset of codewords to drive electrodes 214. By doing so, address drivers 116 are configured to drive display panels 102 and 104 separately at different times, i.e., during non-overlapping time periods.

Resistors 206 may each have any suitable impedance. Resistors 206 may each have the same impedance, or resistors 206 may have different impedances depending on the signaling scheme implemented by address drivers 116. Generally speaking, embodiments where lower impedances of resistors 206 are used may have lower refresh times of the pixel arrays in display panels 102 and 104 and embodiments where higher impedances of resistors 206 are used may have higher refresh times of the pixel arrays in display panels 102 and 104. Each pixel in display panels 102 and 104 may be represented by a capacitance 208. As the impedance of resistors 206 increases, the RC time constant also increases to cause increased refresh times. Likewise, the RC time constant decreases to cause decreased refresh times as the impedance of resistors 206 decreases. Embodiments with higher impedances of resistors 206 may also have lower power consumption and costs from using components with reduced current tolerances than embodiments where lower impedances of resistors 206 are used.

In display panel 102, each cross point of electrodes 202 and electrodes 204 operates a different one of the pixels in the pixel array. The combination of driving signals on electrodes 202 and electrodes 204 from data drivers 114 and address drivers 116, respectively, causes the state of each pixel in the pixel array of display panel 102 to be selected. Similarly, each cross point of electrodes 212 and electrodes 214 operates a different one of the pixels in the pixel array in display panel 104. The combination of driving signals on electrodes 212 and electrodes 214 from data drivers 114 and address drivers 116, respectively, causes the state of each pixel in the pixel array of display panel 104 to be selected.

The use of resistors 206 between driver lines 120 forms a voltage divider circuit on each electrode 204 and 214 at a node between two or more resistors 206. The voltages formed at this node from the driving signals on driver lines 120 are used in conjunction with the voltages on a corresponding electrode 202 to select a state of a pixel in the pixel array. In other embodiments, resistors 206 may be replaced with other suitable circuit elements that provide an impedance between driver lines 120 and electrodes 204 and 214.

The pixels in the pixel arrays are bistable in one embodiment such that they each operate in one of two different states. Depending on the type of pixels in the pixel arrays, the states of each pixel may be to reflect or not reflect light or transmit or not transmit light. The driving signals from data drivers 114 and address drivers 116 cause the pixels in display panels 102 and 104 to modulate light to convey the display information to a user.

Although each electrode 204 and 214 is shown in FIG. 2 as being connected to two driver lines 118 via resistors 206, each electrode 204 and 214 may be connected to additional driver lines 118 via resistors 206 in other embodiments.

In operation, controller 110 causes pages of display information to be displayed on display panels 102 and 104. To display information on display panel 102, controller 110 provides display information and control signals to data drivers 114 and address drivers 116. Data drivers 114 generate and provide driving signals that are received on driver lines 118 and provided to both display panels 102 and 104. Simultaneous with the driving signals from data drivers 114, address drivers 116 generate and provide combinations of driving signals (i.e., codewords) that are received on the set of driver lines 120 that corresponds to display panel 102 to cause the display information to appear in display panel 102. To display information on display panel 104, controller 110 provides display information and control signals to data drivers 114 and address drivers 116. Data drivers 114 generate and provide driving signals that are received on driver lines 118 and provided to both display panels 102 and 104. Simultaneous with the driving signals from data drivers 114, address drivers 116 generate and provide combinations of driving signals (i.e., codewords) that are received on the set of driver lines 120 that corresponds to display panel 104 to cause the display information to appear in display panel 104.

Controller 110 provides the pages for each display panel 102 and 104 during different time periods so that only one of display panel 102 and 104 is updated with a new page (i.e., refreshed) at a time. The pages continue to be displayed by display panels 102 and 104 until controller 110 updates a page. Controller 110 may update each page periodically or in response to a user input received by input/output unit 122.

FIG. 1B illustrates an embodiment of an e-reader 100B. In e-reader 100B, display panels 102 and 104, controller 110, memory 112, data drivers 114, address drivers 116, and input/output unit 122 operate as described above with reference to e-reader 100A.

E-reader 100B includes two separate substrates 124A and 124B. Substrate 124A includes display panel 102, a portion 106A of resistor multiplexer 106 (shown in FIG. 1A), controller 110, memory 112, data drivers 114, address drivers 116, and input/output unit 122. Substrate 124B includes display panel 104 and a portion 106B of resistor multiplexer 106. Substrates 124A and 124B are joined with any suitable connection (not shown) that allows driver lines 118 and driver lines 120B to be provided to display panel 104 and portion 106B of resistor multiplexer 106.

In the embodiment of FIG. 1B, resistor multiplexer 106 includes portions 106A and 106B. Portions 106A and 106B of resistor multiplexer 106 are connected to mutually exclusive subsets 120A and 120B of driver lines 120. Accordingly, driver lines 120A connect to the series of electrodes 204 in display panel 102 and driver lines 120B connect to the series of electrodes 214 in display panel 104. In one embodiment, the subsets of driver lines 120A and 120B each include 300 driver lines. In other embodiments, the subsets of driver lines 120A and 120B each include other numbers of driver lines.

Address drivers 116 operate as described above by providing different subsets of codewords to display panels 102 and 104 across portions 106A and 106B, respectively, using the subsets of driver lines 120A and 120B, respectively.

FIG. 1C illustrates an embodiment of an e-reader 100C. In e-reader 100C, display panels 102 and 104, controller 110, memory 112, and input/output unit 122 operate as described above with reference to e-reader 100A.

Like e-reader 100B, e-reader 100C includes two separate substrates 124A and 124B. Substrate 124A includes display panel 102, portions 106B and 106C of resistor multiplexer 106 (shown in FIG. 1A), controller 110, memory 112, data drivers 114A, address drivers 116A, and input/output unit 122. Substrate 124B includes display panel 104 and portions 106E and 106F of resistor multiplexer 106. Substrates 124A and 124B are joined with any suitable connection (not shown) that allows driver lines 118 and driver lines 120 to be provided to display panel 104 and portion 106E of resistor multiplexer 106.

Data drivers 114A are configured to separately drive different portions of display panels 102 and 104 using driver lines 118A and 118B, respectively. Accordingly, driver lines 118A connect to a first portion of electrodes 202 in a portion 102A of display panel 102 and a first portion of electrodes 212 a portion 104A of in display panel 104. Driver lines 118B connect to a second portion of electrodes 202 in a portion 102B of display panel 102 and a second portion of electrodes 212 a portion 104B of in display panel 104. Data drivers 114A generate and provide driving signals on driver lines 118A to update portions 102A and 104A of display panels 102 and 104, respectively. Likewise, data drivers 114A generate and provide driving signals on driver lines 118B to update portions 102B and 104B of display panels 102 and 104, respectively. In one embodiment, driver lines 118A and 118B each include 638 driver lines. In other embodiments, driver lines 118A and 118B each include other numbers of driver lines.

In the embodiment of FIG. 1C, resistor multiplexer 106 includes portions 106C, 106D, 106E, and 106F. Portions 106C, 106D, 106E, and 106F of resistor multiplexer 106 are connected to driver lines 120. Portions 106C and 106E provide driver lines to portions 106D and 106F, respectively, of resistor multiplexer 106. Accordingly, driver lines 120 connect to the series of electrodes 204 in display panel 102 and the series of electrodes 214 in display panel 104. In one embodiment, driver lines 120 include 600 driver lines. In other embodiments, driver lines 120 include other numbers of driver lines.

Address drivers 116A operate by providing different subsets of codewords to separately drive the rows of portions 102A and 102B of display panel 102 and to separately drive the rows of portions 104A and 104B of display panel 104. Address drivers 116A provide a first subset of codewords to portion 106C of resistor multiplexer 106 to drive the rows of portion 102A of display panel 102, a second subset of codewords to portion 106D of resistor multiplexer 106 to drive the rows of portion 102B of display panel 102, a third subset of codewords to portion 106E of resistor multiplexer 106 to drive the rows of portion 104A of display panel 104, and a fourth subset of codewords to portion 106F of resistor multiplexer 106 to drive the rows of portion 104B of display panel 104.

To update display panel 102, data drivers 114A provide driving signals on driver lines 118A and address drivers 116A simultaneously provide driving signals on driver lines 120 that correspond to portion 106C to update portion 102A. Likewise, data drivers 114A provide driving signals on driver lines 118B and address drivers 116A simultaneously provide driving signals on driver lines 120 that correspond to portion 106D to update portion 102B.

To update display panel 104, data drivers 114A provide driving signals on driver lines 118A and address drivers 116A simultaneously provide driving signals on driver lines 120 that correspond to portion 106E to update portion 104A. Likewise, data drivers 114A provide driving signals on driver lines 118B and address drivers 116A simultaneously provide driving signals on driver lines 120 that correspond to portion 106F to update portion 104B.

In the above embodiments, data drivers 114 and 114A are described as providing driving signals for columns of display panels 102 and 104 and address drivers 116 and 116A are described as providing driving signals across resistor multiplexer 106 for rows of display panels 102 and 104. In other embodiments, data drivers 114 and 114A may provide driving signals to rows of display panels 102 and 104 and address drivers 116 and 116A may provide driving signals across resistor multiplexer 106 to columns of display panels 102 and 104.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. An apparatus comprising:
first and second display panels having first and second pixel arrays, respectively, with first and second series of generally parallel electrodes, respectively, that extend across the first and second pixels arrays, respectively; and
a resistor multiplexer having a first series of driver lines for receiving first driving signals;
wherein each of the first and the second series of electrodes is connected to a respective plurality of the first series of driver lines via a respective impedance, and wherein the first driving signals contained by each of the plurality of the driver lines are independent of each other.

2. The apparatus of claim 1 wherein a first number of the first series of driver lines is less than a second number of the first and the second series of generally parallel electrodes.

3. The apparatus of claim 1 wherein a first set of combinations of the first driving signals correspond to the first series of electrodes, wherein a second set of combinations of the first driving signals correspond to the second series of electrodes, and wherein the first and the second sets of combinations are mutually exclusive.

4. The apparatus of claim 1 where a first set of the pluralities of the first series of driver lines connects to the first series of electrodes, wherein a second set of the pluralities of the first series of driver lines connects to the second series of electrodes, and wherein the first and the second sets of the pluralities of the first series of driver lines are mutually exclusive.

5. The apparatus of claim 1 further comprising:
a first series of drivers configured to provide the first driving signals to the series of driver lines.

6. The apparatus of claim 5 wherein the first series of drivers is configured to provide a first set of the first driving signals to a first set of the series of driver lines that correspond to the first series of electrodes during a first time period, and wherein the first series of drivers is configured to provide a second set of the first driving signals to a second set of the series of driver lines that correspond to the second series of electrodes during a second time period.

7. The apparatus of claim 5 wherein the first and the second pixel arrays, have third and fourth series of generally parallel electrodes, respectively, that extend across the first and second pixels arrays, respectively, generally perpendicular to the first and the second series of electrodes, respectively.

8. The apparatus of claim 7 further comprising:
a second series of drivers configured to provide second driving signals to the third and the fourth series of generally parallel electrodes.

9. The apparatus of claim 1 wherein the first and the second display panels are each flexible.

10. The apparatus of claim 1 further comprising:
a substrate that includes the first and the second display panels.

11. The apparatus of claim 1 further comprising:
a first substrate that includes the first display panel; and
a second substrate that includes the second display panel.

12. The apparatus of claim 1 wherein the first and the second display panels are one of electrophoretic display panels and liquid crystal display panels.

13. A method comprising:
providing a first set of codewords to a resistor multiplexer to update a first display panel during a first time period; and
providing a second set of codewords to the resistor multiplexer to update a second display panel during a second time period that is subsequent to the first time period;
wherein the first and the second sets of codewords are mutually exclusive.

14. The method of claim 13 further comprising:
receiving a user input; and
providing the first set of codewords to the resistor multiplexer to update the first display panel in response to receiving the user input.

15. The method of claim 13 further comprising:
providing the first set of codewords to a first portion of the resistor multiplexer on a first substrate; and
providing the second set of codewords to a second portion of the resistor multiplexer on a second substrate.

16. The method of claim 15 further comprising:
providing a first subset of the first set of codewords to the first portion of the resistor multiplexer to update a first portion of the first display panel; and
providing a second subset of the first set of codewords to the first portion of the resistor multiplexer to update a second portion of the first display panel.

17. A system comprising:
means for generating first driving signals configured to update first and second display panels during first and second time periods, respectively; and
means for providing a first subset of the first driving signals to the first display panel during the first time period and a second subset of the first driving signals to the second display panel during the second time period;
wherein the first and the second subsets of the first driving signals are mutually exclusive.

18. The system of claim 17 further comprising:
means for providing second driving signals configured to update the first and the second display panels in conjunction with the first and the second subsets of the first driving signals, respectively.

19. The system of claim 17 further comprising:
means for providing the first subset of the first driving signals to the first display panel in response to a first user input and the second subset of the first driving signals to the second display panel in response to a second user input.

20. The system of claim 17 wherein the first and the second display panels are one of electrophoretic display panels and liquid crystal display panels.
